(19) United States
(12) Patent Application Publication
(10) Pub. No.: US 2014/0280610 A1
(43) Pub. Date: Sep. 18, 2014

(54) IDENTIFICATION OF USERS FOR INITIATING INFORMATION SPREADING IN A SOCIAL NETWORK

(71) Applicant: INTERNATIONAL BUSINESS MACHINES CORPORATION, Armonk, NY (US)

(72) Inventors: Jilin Chen, Mountain View, CA (US); Kyumin Lee, College Station, TX (US); Jalal U. Mahmud, San Jose, CA (US); Jeffrey W. Nichols, San Jose, CA (US); Michelle X. Zhou, Saratoga, CA (US)

(73) Assignee: INTERNATIONAL BUSINESS MACHINES CORPORATION, Armonk, NY (US)

(21) Appl. No.: 13/799,156

(22) Filed: Mar. 13, 2013

(51) Int. Cl. H04L 12/58

(52) U.S. Cl. CPC H04L 51/32
USPC 709/206

(57) ABSTRACT

Embodiments of the invention relate to identifying users for initiating information spreading in social network. In one embodiment, information for one or more users of a social network is collected and one or more features for each of the one or more users based on the collected information is computed. The one or more features are compared with a statistical model and calculating a probability that each of the one or more users will spread a message received from outside their social network based on the comparison.

This invention was made with Government support under W911NF-12-C-0028 awarded by Army Research Office. The Government has certain rights in the invention.

### BACKGROUND

The present invention relates generally to social networking, and more specifically, for identifying users for initiating information spreading in a social network.

Social networking applications and social media are becoming more and more widely used in todays society by individual users and businesses. This growth in usage has lead to an increase in the desire to understand and model the behavior of users and the spread of information in social media. Such modeling can benefit a number of objectives, such as viral marketing and spreading a message for social/political reasons as well as for protecting certain population/organization such as government. For example, when negative messages are spread in social media, it may be desirable to spread positive messages to balance that affect of the negative messages. In another example, a business launching an online advertising campaign may desire the campaign to be widespread in social media in order to gain maximum benefit from their campaign.

In order to achieve a desired level of information spreading in a social network, it is important to identify users of the social network to spread the desired information.

### BRIEF SUMMARY

Embodiments of the invention include a system, computer program, and method of identifying users for initiating information spreading in a social network the system. In one embodiment, information for one or more users of a social network is collected and one or more features for each of the one or more users based on the collected information is computed. The one or more features are compared with a statistical model and calculating a probability that each of the one or more users will spread a message received from outside their social network based on the comparison.

Additional features and advantages are realized through the techniques of the present invention. Other embodiments and aspects of the invention are described in detail herein and are considered a part of the claimed invention. For a better understanding of the invention with the advantages and the features, refer to the description and to the drawings.

### BRIEF DESCRIPTION OF THE SEVERAL VIEWS OF THE DRAWINGS

The subject matter which is regarded as the invention is particularly pointed out and distinctly claimed in the claims at the conclusion of the specification. The foregoing and other features, and advantages of the disclosure are apparent from the following detailed description taken in conjunction with the accompanying drawings in which:

FIG. 1 illustrates a flow diagram of a method for identifying users for initiating information spreading in social network in accordance with an embodiment;

FIG. 2 illustrates a flow diagram of a method for building a statistical model for identifying users for initiating information spreading in social network; and

FIG. 3 illustrates a block diagram of a computer system for use in practicing the teachings herein.

### DETAILED DESCRIPTION

In accordance with exemplary embodiments, a method is provided for identifying users for initiating information spreading in a social network. In exemplary embodiments, the method is configured to identify one or more users of a social network site that are likely to spread a message received from another user that is not currently in the users' social network. The method includes capturing information relating to a user and their historic use of the social network. The captured information relates to the user's willingness, ability and readiness to spread information. Based on an analysis of the captured information, a statistical model is built to predict the likelihood that a user will spread a message received from a source outside their social network.

Referring now to FIG. 1, a flow diagram illustrating a method 200 for identifying users for initiating information spreading in social network in accordance with an embodiment is shown. As illustrated at block 202, the method 200 includes collecting information for one or more users of a social network. In exemplary embodiments, the one or more users may be randomly selected or selected based on criteria such as their location or their interest in a particular subject. Next, as shown at block 204, the method 200 includes computing one or more features for each of the one or more users based on the collected information. In exemplary embodiments, the one or more features may include, but are not limited to, personality features, profile features, social network features, activity features, information-spreading features, readiness features, and relatedness features. Next, as shown at block 206, the method 200 includes ccomparing the one or more features with a statistical model. The method 200 concludes at block 208 by calculating a probability that each of the one or more users will spread a message received from outside their social network based on the comparison. In exemplary embodiments, the statistical model is configured to identify users of that are likely to re-transmit, or spread, a message received from a source outside of their social network based on the one or more features.

In exemplary embodiments, the personality features may be based on a psycho-linguistic analysis of the text of a user's social media updates or postings. In one embodiment, the personality features may be obtained by using a Linguistic Inquiry and Word Count (LIWC) dictionary. In another embodiment, the personality features may be obtained by using a Big5 model of personality traits and by using correlations of Big5 and LIWC features.

In exemplary embodiments, the profile features may be based on information relating to a user's social media profile. The profile features may include, but are not limited to, longevity of a user account, a length of screen name, the existence and length of a user profile description, and the existence of a user profile URL. In exemplary embodiments, these profile features may indicate a user with a high level of experience, skills and knowledge of usage of the social network.

In exemplary embodiments, the social network features may be based on information from the activity of the user's social network. The social network features may include, but are not limited to, a number of friends, a number of users being followed or following, and a ratio of friends and followers. In exemplary embodiments, the social network features indicate a user's socialness. For example, a more social person may be following a large number of users (following in Twitter® is similar to being friends in other social media). In addition, a person who is more social and active often has many friends or followers.

In exemplary embodiments, the activity features may be captured from user's behavior in social network. The activity features may include, but are not limited to, a number of status messages during a predetermined period, a number of direct mention per status message, a number of URLs per status message, a number of hash tags per status message, a number of status messages per day during (i.e., total number of posted status messages/longevity), a number of status messages per day during a predetermined period, a number of direct mention per day during the predetermined period, a number of URLs per day during the predetermined period, and number of hash tags per day during the predetermined period. In exemplary embodiments, these activity features reflect a higher level of general activity. In exemplary embodiments, the predetermined period may be a day, a week, a month or any other suitable amount of time.

In exemplary embodiments, the information-spreading features may be captured from a user's behavior in social network and are closely tied with user's information spreading behavior. The information-spreading features may include, but are not limited to, a number of message shares (such as re-tweets, or re-posts) per status message, a number of message shares per day during a predetermined period, a rate of sharing a directly requested message, and a rate of message sharing a message from someone outside the user's social network. In exemplary embodiments, these information-spreading features reflect a higher preference of re-tweeting and information spreading.

In exemplary embodiments, the readiness features may be captured from a user's behavior in social network and are designed to measure if a user is ready to spread the information. The readiness features may include, but are not limited to, a user's period of inactivity since last sending a message or posting an update, a user's likelihood of resending a message on the same day when retransmission request was sent, and a user's likelihood of resending a message within the hour when retransmission request was sent.

In exemplary embodiments, the relatedness features may be captured from a user's behavior in social network and may quantify the degree of relatedness between a user and the information to spread. Examples of relatedness may be topic-based relatedness, location-based relatedness or time-based relatedness. In exemplary embodiments, a user may be more likely to spread information if that is related with their topic, location or time.

Referring now to FIG. 2, a flow diagram illustrating a method 300 for building a statistical model for identifying users for initiating information spreading in social network in accordance with an embodiment is shown. As shown at block 302, the method 300 includes identifying a plurality of users of a social network. Next, as shown at block 304, the method includes collecting information for each of the plurality of users of a social network. The method 300 also includes requesting that each of the plurality of users of a social network spread, or re-transmit, a message, as shown at block 306. Next, as shown at block 308, the method 300 includes monitoring the social network to identify a subset of users that spread, or re-transmit, the message. As shown at block 310, the method 300 includes computing one or more features for each of the plurality of users based on the collected information. Finally, as shown at block 312, the method 300 includes building a statistical model for predicting a probability of information spreading based on the one or more features of the subset of users.

In exemplary embodiments, a statistical model can be built for predicting what users in a social network are likely to share a message received from someone outside of their social network based upon one or more of the above features. In exemplary embodiments, the statistical model may be a support vector machine that is trained with collected historical data and then used for prediction. In one embodiment, the statistical model can be used to identify individuals who would not only spread information but also spread information positively (with positive words), negatively (using negative words) or by editing content. In exemplary embodiments, the statistical model can be used to identify one or more common features, or a correlation of multiple features, of the users that spread the requested message.

In one embodiment, the statistical model may be used to classify user into two categories, a likely to share category or unlikely to share category. In another embodiment, the statistical model may be used to generate a score indicative of a user's likelihood to share, or re-transmit, a message received from a user not within the user's social network. In yet another embodiment, the statistical model may be used to rank a plurality of users based on their likelihood to share, or re-transmit, a message received from a user not within the user's social network. Since a statistical model may not be 100% accurate, selecting people using classification output may not provide the best results. For example, a statistical model may predict user A as a will re-transmit a message with a 60% probability, but user A may not actually re-transmit the message. In one embodiment, the user selection approach could select top-K percent users based on their calculated probability of re-transmitting or it could select users for whom the probability of re-transmit is above a certain threshold (e.g., more than 60%).

FIG. 3 illustrates a block diagram of a computer system 100 for use in practicing the teachings herein. The methods described herein can be implemented in hardware, software (e.g., firmware), or a combination thereof. In an exemplary embodiment, the methods described herein are implemented in hardware, and may be part of the microprocessor of a special or general-purpose digital computer, such as a personal computer, workstation, minicomputer, or mainframe computer. The computer system 100 therefore includes general-purpose computer 101.

In an exemplary embodiment, in terms of hardware architecture, as shown in FIG. 3, the computer 101 includes a processor 105, memory 110 coupled to a memory controller 115, and one or more input and/or output (I/O) devices 140, 145 (or peripherals) that are communicatively coupled via a local input/output controller 135. The input/output controller 135 can be, for example but not limited to, one or more buses or other wired or wireless connections, as is known in the art. The input/output controller 135 may have additional elements, which are omitted for simplicity, such as controllers, buffers (caches), drivers, repeaters, and receivers, to enable communications. Further, the local interface may include address, control, and/or data connections to enable appropriate communications among the aforementioned components.

The processor 105 is a hardware device for executing hardware instructions or software, particularly that stored in memory 110. The processor 105 can be any custom made or commercially available processor, a central processing unit (CPU), an auxiliary processor among several processors associated with the computer 101, a semiconductor based microprocessor (in the form of a microchip or chip set), a macroprocessor, or generally any device for executing instructions. The processor 105 includes a cache 170, which may include, but is not limited to, an instruction cache to speed up executable instruction fetch, a data cache to speed up data fetch and store, and a translation lookaside buffer (TLB) used to speed up virtual-to-physical address translation for both executable instructions and data. The cache 170 may be organized as a hierarchy of more cache levels (L1, L2, etc.).

The memory 110 can include any one or combination of volatile memory elements (e.g., random access memory (RAM, such as DRAM, SRAM, SDRAM, etc.)) and nonvolatile memory elements (e.g., ROM, erasable programmable read only memory (EPROM), electronically erasable programmable read only memory (EEPROM), programmable read only memory (PROM), tape, compact disc read only memory (CD-ROM), disk, diskette, cartridge, cassette or the like, etc.). Moreover, the memory 110 may incorporate electronic, magnetic, optical, and/or other types of storage media. Note that the memory 110 can have a distributed architecture, where various components are situated remote from one another, but can be accessed by the processor 105.

The instructions in memory 110 may include one or more separate programs, each of which comprises an ordered listing of executable instructions for implementing logical functions. In the example of FIG. 3, the instructions in the memory 110 include a suitable operating system (OS) 111. The operating system 111 essentially controls the execution of other computer programs and provides scheduling, input-output control, file and data management, memory management, and communication control and related services.

In an exemplary embodiment, a conventional keyboard 150 and mouse 155 can be coupled to the input/output controller 135. Other output devices such as the I/O devices 140, 145 may include input devices, for example but not limited to a printer, a scanner, microphone, and the like. Finally, the I/O devices 140, 145 may further include devices that communicate both inputs and outputs, for instance but not limited to, a network interface card (NIC) or modulator/demodulator (for accessing other files, devices, systems, or a network), a radio frequency (RF) or other transceiver, a telephonic interface, a bridge, a router, and the like. The system 100 can further include a display controller 125 coupled to a display 130. In an exemplary embodiment, the system 100 can further include a network interface 160 for coupling to a network 165. The network 165 can be an IP-based network for communication between the computer 101 and any external server, client and the like via a broadband connection. The network 165 transmits and receives data between the computer 101 and external systems. In an exemplary embodiment, network 165 can be a managed IP network administered by a service provider. The network 165 may be implemented in a wireless fashion, e.g., using wireless protocols and technologies, such as WiFi, WiMax, etc. The network 165 can also be a packet-switched network such as a local area network, wide area network, metropolitan area network, Internet network, or other similar type of network environment. The network 165 may be a fixed wireless network, a wireless local area network (LAN), a wireless wide area network (WAN) a personal area network (PAN), a virtual private network (VPN), intranet or other suitable network system and includes equipment for receiving and transmitting signals.

If the computer 101 is a PC, workstation, intelligent device or the like, the instructions in the memory 110 may further include a basic input output system (BIOS) (omitted for simplicity). The BIOS is a set of essential routines that initialize and test hardware at startup, start the OS 111, and support the transfer of data among the hardware devices. The BIOS is stored in ROM so that the BIOS can be executed when the computer 101 is activated. When the computer 101 is in operation, the processor 105 is configured to execute instructions stored within the memory 110, to communicate data to and from the memory 110, and to generally control operations of the computer 101 pursuant to the instructions.

Technical effects and benefits include method and systems for identifying users in a social network that are likely to spread, or re-transmit, a message that is received from someone outside of their social network.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiments were chosen and described in order to best explain the principles of the disclosure and the practical application, and to enable others of ordinary skill in the art to understand the disclosure for various embodiments with various modifications as are suited to the particular use contemplated.

Further, as will be appreciated by one skilled in the art, aspects of the present disclosure may be embodied as a system, method, or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

What is claimed is:

1. A method for identifying users for initiating information spreading in social network, the method comprising:
collecting information for one or more users of a social network;
computing one or more features for each of the one or more users based on the collected information;
compare the one or more features with a statistical model; and
calculating a probability that each of the one or more users will spread a message received from outside their social network based on the comparison.

2. The method of claim 1, wherein the method further comprises creating the statistical model, the creating comprising:
requesting that each of the one or more users of a social network spread a message;
monitoring the social network to identify a subset of users that spread the message; and
building the statistical model based on the one or more features of the subset of users.

3. The method of claim 2, wherein identifying the subset of users comprises determining which of the one or more users re-transmitted the message during a predetermined period of time.

4. The method of claim 3, wherein the one or more features comprises at least one of: a number of message shares per status message; a number of message shares per day during a predetermined period; a rate of sharing a directly requested message; and a rate of message sharing a message from outside their social network.

5. The method of claim 1, wherein the statistical model is a support vector machine that is trained with collected historical data collected from users of the social network.

6. The method of claim 5, wherein calculating the probability that each of the one or more users will spread the message includes inputting the one or more features of each of the one or more users into the support vector machine.

7. The method of claim 1, wherein the one or more features include at least one of a personality feature, a profile feature, a social network feature, a activity feature, an information-spreading feature, a readiness feature, and a relatedness feature.

8. The method of claim 1, wherein the method further comprises classifying each of the one or more users as likely to re-transmit or unlikely to re-transmit based upon the probability.

9. The method of claim 1, wherein the method further comprises ranking the one or more users in descending order based on the probability.

10. A computer system for identifying users for initiating information spreading in social network, the computer system comprising:
a memory device, the memory device having computer readable computer instructions; and
a processor for executing the computer readable instructions, the instructions including:
collecting information for one or more users of a social network;
computing one or more features for each of the one or more users based on the collected information;
comparing the one or more features with a statistical model; and
calculating a probability that each of the one or more users will spread a message received from outside their social network based on the comparison.

11. The computer system of claim 10, further comprising creating the statistical model by:
requesting that each of the one or more users of a social network spread a message;
monitoring the social network to identify a subset of users that spread the message; and
building the statistical model based on the one or more features of the subset of users.

12. A computer program product for identifying users for initiating information spreading in social network, the computer program product comprising:
a computer readable storage medium having program code embodied therewith, the program code executable by a processor to:
collect information for one or more users of a social network;
compute one or more features for each of the one or more users based on the collected information;
compare the one or more features with a statistical model; and
calculate a probability that each of the one or more users will spread a message received from outside their social network based on the comparison.

13. The computer program product of claim 12, further comprising creating the statistical model by:
requesting that each of the one or more users of a social network spread a message;
monitoring the social network to identify a subset of users that spread the message; and
building the statistical model based on the one or more features of the subset of users.

14. The computer program product of claim 13, wherein identifying the subset of users comprises determining which of the one or more users re-transmitted the message during a predetermined period of time.

15. The computer program product of claim 14, wherein the an information-spreading feature comprises at least one of: a number of message shares per status message; a number of message shares per day during a predetermined period; a rate of sharing a directly requested message; and a rate of message sharing a message from outside their social network.

16. The computer program product of claim 12, wherein the statistical model is a support vector machine that is trained with collected historical data collected from users of the social network.

17. The computer program product of claim 16, wherein calculating the probability that each of the one or more users will spread the message includes inputting the one or more features of each of the one or more users into the support vector machine.

18. The computer program product of claim 12, wherein the one or more features include a personality feature, a profile feature, a social network feature, a activity feature, an information-spreading feature, a readiness feature, and a relatedness feature.

19. The computer program product of claim 12, further comprising classifying each of the one or more users as likely to re-transmit or unlikely to re-transmit based upon the probability.

20. The computer program product of claim 12, further comprising ranking the one or more users in descending order based on the probability.
